(19) United States
(12) Patent Application Publication
(10) Pub. No.: US 2011/0049854 A1
(43) Pub. Date: Mar. 3, 2011

(54) ASSEMBLY FOR MOUNTING A STEERING WHEEL ON THE STEERING COLUMN OF AN AUTOMOBILE

(75) Inventor: Franck Mencarelli, Le Perray En Yvelines (FR)

(73) Assignee: RENAULT S.A.S, Boulogne-billancourt (FR)

(21) Appl. No.: 12/864,319

(22) PCT Filed: Jan. 12, 2009
(86) PCT No.: PCT/FR09/50039

§ 371 Date: Nov. 16, 2010

(30) Foreign Application Priority Data
Jan. 24, 2008 (FR) 0850456

(51) Int. Cl. B62D 1/16

(52) U.S. Cl. 280/779

(57) ABSTRACT

An assembly for mounting a steering wheel on the steering column of an automobile, the assembly including first flutes formed at the steering wheel and adapted to be fitted into second flutes extending along the steering column and a fastening screw adapted for engagement through the steering wheel and for interaction with a tapping formed axially at the end of the steering column. Once inserted through the steering wheel, the fastening screw can be screwed into the tapping if and only if the first flutes and the second flutes are at least partially engaged.

The present invention relates to an arrangement making it possible to angularly position and rigidly attach a steering wheel to a steering column.

The invention finds a particularly advantageous, but not exclusive, application in the motor vehicle field.

In order to attach a steering wheel to a steering column, it is known practice to use a simple screw which, on the one hand, is housed in a through hole arranged at the center of the hub of said steering wheel, and on the other hand is screwed into a tapping machined axially at the end of said steering column. In order to reduce production costs as much as possible, it is a standard fastening screw that is conventionally used on the industrial scale.

The action of this fastening screw is usually supplemented by splines that are more particularly responsible for transmitting the rotary forces between the steering wheel and the steering column. In this way, a first set of splines is normally arranged in the hole passing through the steering wheel, while a second extends along the steering column. The assembly is arranged so as to engage longitudinally when the steering wheel is inserted into the end of the steering column.

In practice, the two sets of splines are also used to angularly position the steering wheel relative to the steering column. The presence of an error-preventing system makes it possible to define a single mounting position, in which the steering wheel is perfectly centered when the steered wheels associated with the steering column are absolutely straight.

This type of arrangement, however, has the drawback of causing mounting difficulties some of which are likely to harm the quality of assembly, and even to cause damage.

Specifically, by virtue of its standard character, the fastening screw has a length that is usually longer than that of the hole arranged through the hub of the steering wheel. Consequently, it is capable of being screwed into the tapping of the steering column before the two sets of splines are longitudinally engaged.

By forcing a little, which is relatively easy since screwing is usually a mechanized operation, it is possible to fix the steering wheel without it being correctly positioned from an angular point of view, despite the presence of the error-preventing system.

In this way therefore and at best, the steering wheel will have to be reinstalled subsequently during an awkward reworking job. But at worst, it will absolutely be necessary to replace the steering wheel due to the damage to its splines, because the hub is these days usually made of magnesium.

Therefore, the technical problem to be solved by the subject of the present invention is to propose an arrangement for mounting a steering wheel on a steering column of a motor vehicle, said arrangement comprising on the one hand first splines that are made on the steering wheel and that are intended to be fitted into second splines extending along the steering column and, on the other hand, a fastening screw that is designed to be engaged through the steering wheel and to interact with a tapping arranged axially at the end of the steering column, an arrangement which would make it possible to prevent the problems of the prior art by ensuring notably a precise angular positioning of the steering wheel while remaining compatible with the use of a standard fastening screw.

The solution to the technical problem posed consists, according to the present invention, in that, once engaged through the steering wheel, the fastening screw is capable of being screwed into the tapping if and only if the first splines and the second splines are at least partially fitted.

The principle therefore consists in allowing the steering wheel to be fastened only if the latter is previously positioned appropriately at the end of the steering column. Specifically the assembly is arranged so that it is impossible to screw the fastening screw into the tapping unless the steering wheel is correctly oriented angularly relative to the steering column.

In contrast, this means that, if the steering wheel is placed in the only position compatible with the error-preventing system, the longitudinal fitting of the splines will be able to occur naturally, thus validating the angular positioning step. Gradually as the steering wheel is inserted on the end of the steering column, the fastening screw will progressively approach the tapping until they make actual contact. The screwing operation proper can then commence; the fastening step being completed only with the steering wheel butting against the steering column and the tightening of the fastening screw in the tapping.

As opposed to what happens in the prior art, the steps of angular positioning and of fastening can in no circumstances occur in a concomitant manner. The arrangement that is the subject of the invention imposes a precise order of mounting, in which the angular setting of the steering wheel must mandatorily occur before application of the fastening step.

Be that as it may, the invention as thus defined has the advantage of systematically ensuring an appropriate angular positioning of the steering wheel. This makes it possible to prevent both rework and scrappage and therefore, in the end, to limit the costs of mounting.

It is moreover important to specify that the invention is independent of the length of the screw which may therefore remain completely standard. It is in fact the relative positioning between the screw, the tapping and the two types of splines that is adapted so that said screw can interact with said tapping only after at least partial fitting of said splines, that is to say only after the angular positioning of the steering wheel.

The present invention also relates to the features that will emerge during the following description and that are to be considered in isolation or in all their possible technical combinations.

This description, given as a nonlimiting example, is intended to provide a better understanding of what the invention involves and how it can be embodied. It is moreover given with reference to the appended drawings in which:

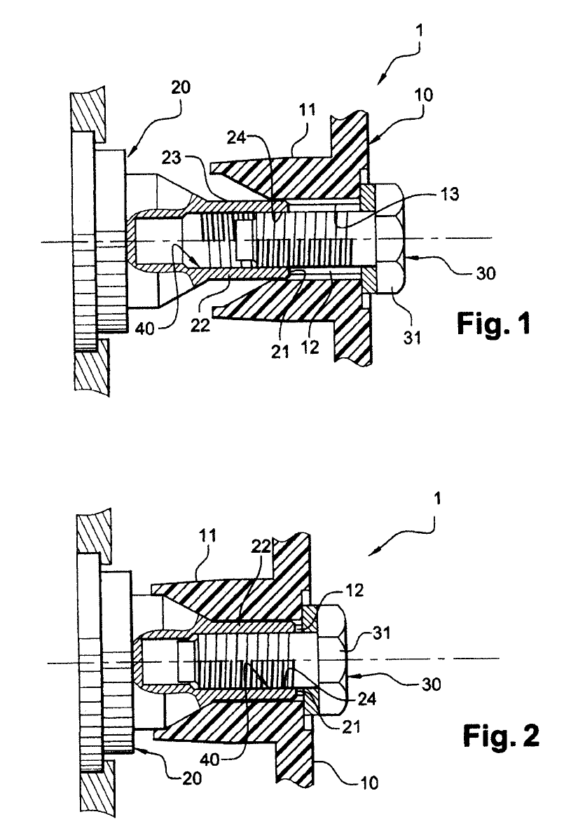

FIG. 1 is an axial section illustrating the mounting of a steering wheel on a steering column of a motor vehicle.

FIG. 2 is a view similar to FIG. 1, but once the mounting is complete.

For reasons of clarity, the same elements have been indicated by identical reference numbers. Similarly, only the elements essential for the understanding of the invention have been shown and this is done in a schematic manner and not to scale.

FIGS. 1 and 2 therefore show an arrangement 1 which makes it possible both to angularly position and to rigidly attach a steering wheel 10 to a steering column 20 of a motor vehicle. In this respect, it can now be seen that the steering wheel 10 is firmly intended to be inserted onto the end 21 of the steering column 20. This is why it is furnished with a hub 11 at the center of which a through hole 12 is arranged the shape of which substantially matches that of the most distal portion 22 of the column 20.

With respect more particularly to the angular positioning of the steering wheel 10, the arrangement 1 makes use of a conventional system of matching splines. On the steering wheel 10 there is therefore a first series of splines 13 arranged longitudinally inside the through hole 12, while, on the steering column 20, note the presence of a second series of splines 23 which are also placed longitudinally and extend radially. By virtue of the existence of an error-preventing system that cannot be seen here, the assembly is arranged so that there is only one angular position in which the first splines 13 can fit longitudinally into the second splines 23 when the steering wheel 10 is inserted onto the steering column 20.

With respect however to securing the steering wheel 10 to the steering column 20, the arrangement 1 provides a fastening screw 30 which is capable, on the one hand, of being engaged through the steering wheel 10, and, on the other hand, of interacting with a tapping 40 arranged axially at the end 21 of said column 20. Very logically, it is in the through hole 12 that the fastening screw 30 is engaged through the steering wheel 10, since it is responsible for receiving the distal portion 22 of the steering column 20; the head 31 of the screw 30 then pressing against the front face of the hub 11.

As can be seen notably in FIG. 1, and according to the subject of the present invention, once engaged through the steering wheel 10, the fastening screw 30 is capable of being screwed into the tapping 40 if and only if the first splines 13 and the second splines 23 are at least partially engaged.

It is clear in this instance that it is not simply the combined presence of the first splines 13, the second splines 23, the fastening screw 30 and the tapping 40 that constitutes the invention, such an association being perfectly well known in the prior art. But it is the relative disposition between these various elements relative to one another that makes it possible to separate and sequence over time the steps of angular positioning and of fastening.

As a result of this, a multitude of embodiments are possible, depending on the size of the various elements and of their installation on their respective supports. Thought is given here notably to the fact that the fastening screw 30 can be longer or shorter than the through hole 12, and/or that the tapping 40 can be arranged to a greater or lesser depth inside the steering column 20, and/or that the second splines 23 can be arranged directly next to or further back from the end 21 of the steering column 20, and/or that the first splines 13 can be larger or smaller.

According to a currently preferred embodiment of the invention, the arrangement 1 also comprises a housing 24 that is arranged upstream of the tapping 40 relative to the end 21 of the steering column 20.

This means in other words that the tapping 40 is arranged at a distance from the end 21 of the steering column 20. This feature makes it possible here above all to compensate for the fact that the fastening screw 30 is longer than the through hole 12. According to FIG. 1, the depth of the housing is fixed so that the thread of the screw 30 cannot reach that of the tapping unless the first splines 13 are engaged in the second splines 23.

According to a particular feature of this embodiment, the second splines 23 extend notably over the portion of steering column 20 in which the housing 24 is arranged.

In this particular embodiment, chosen only as an example, the housing 24 is in fact a bore that is concentric with the tapping 40 and that has a section matching that of the fastening screw 30.

This feature advantageously allows the housing 24 to fulfill a guidance function with respect to the threaded portion of the fastening screw 30, which accordingly makes it easier to secure the steering wheel 10 to the end 21 of the steering column 20.

According to another particular feature of the invention, the second splines 23 also extend over the portion of the steering column 20 inside which the tapping 40 is arranged.

The value of this feature is that it allows the second splines 23 to be very long. It is therefore possible to give them a size that is comparable with that of the first splines 13, which, in the end, makes it possible to optimize the transmission of the rotary forces between the steering wheel 10 and the steering column 20.

According to another particular feature of the invention, the first splines 13 extend substantially over the whole length of the through hole 12 in the steering wheel 10, which is designed to receive the distal portion 22 of the steering column 20.

Here again, the objective is to reinforce the connection between the steering wheel 10 and the steering column 20, it being understood that it makes sense only if the length of the first splines 13 is substantially equivalent to that of the second splines 23.

Clearly, the invention relates more generally to any motor vehicle furnished with a steering column 20 that can be operated by means of a steering wheel 10, and also having an arrangement 1 as described above.

1-6. (canceled)

7. An arrangement for mounting a steering wheel on a steering column of a motor vehicle, the arrangement comprising:
first splines that are made on the steering wheel and that are configured to be fitted into second splines extending along the steering column;
a fastening screw configured to be engaged through the steering wheel and to interact with a tapping arranged axially at the end of the steering column, once engaged through the steering wheel, the fastening screw configured to be screwed into the tapping if and only if the first splines and the second splines are at least partially engaged; and
a housing arranged upstream of the tapping relative to the end of the steering column.

8. The arrangement as claimed in claim 7, wherein the second splines extend over the portion of steering column in which the housing is arranged.

9. The arrangement as claimed in claim 7, wherein the housing is a bore that is concentric with the tapping and that has a section matching that of the fastening screw.

10. The arrangement as claimed in claim 7, wherein the second splines extend over the portion of steering column in which the tapping is arranged.

11. The arrangement as claimed in claim 7, wherein the first splines extend substantially over the whole length of a through hole that is arranged on the steering wheel to receive the steering column.

12. A motor vehicle comprising:
a steering column that can be operated by a steering wheel; and
an arrangement as claimed in claim 7.
